(19) United States
(12) Patent Application Publication
(10) Pub. No.: US 2011/0088002 A1
(43) Pub. Date: Apr. 14, 2011

(54) METHOD AND PLATFORM FOR GESTURAL TRANSFER OF DIGITAL CONTENT FOR MOBILE DEVICES

(76) Inventor: Carl Johan FREER, Westport, CT (US)

(21) Appl. No.: 12/578,508

(22) Filed: Oct. 13, 2009

(51) Int. Cl. G06F 3/033; G06F 15/16

(52) U.S. Cl. 715/863; 709/204

(57) ABSTRACT

A platform is provided which allows for gesture-initiated transfer of digital content from a mobile device to at least one other device which may also be a mobile device. The platform includes an application that leverages components which help in determining the pose of the mobile device. Upon detecting a gesturing motion (e.g., a throwing or casting motion), the system begins transfer of digital content (such as the current application or a set of pre-packaged information) to the at least one other device. The throwing or casting direction is analyzed to determine the appropriate device or devices to receive the content.

The contents of U.S. Provisional Patent Application Ser. No. 61/094,367 are incorporated herein by reference.

### FIELD OF THE INVENTION

The present invention relates generally to methods and techniques for implementing gesture-initiated transfer of digital content between mobile devices.

The present invention also relates to a platform designed to support gesture-based transfer of digital content between mobile devices.

### BACKGROUND OF THE INVENTION

Mobile computing using mobile devices has several advantages over traditional desktop computing platforms. For example, mobile devices contain information that may not be present on users' home computers, including contact information, schedules, notes, or applications that an individual frequently uses. Further, a mobile device is usually with its owner for a majority of the time, making the information found on the device easily available as well. Given their size and weight, mobile devices can also be physically handled in ways that are not possible with other computing devices, e.g., desktop computers. However, the power within a mobile device is often limited in terms of speed, memory and other capabilities.

It is especially common for users of computing devices, whether mobile or fixed, to share information with others; the amount and kinds of information often varies with the relationship between those who wish to share the information. For example, casual acquaintances may wish to exchange contact information while others may share large sets of data or even entire applications.

Mobile devices vary in their computing capabilities, but most often include a CPU (Central Processing Unit), memory components and a display. More advanced mobile devices contain peripheral components such as a GPS (Global Positioning Service) system, vibrating units, accelerometers and gyroscopes. Each of these components can provide additional information that can help in establishing the context of the user. For example, a GPS system can determine the approximate position of the user, accelerometers can help determine offsets from a starting position, and gyroscopes can aid in establishing the orientation of the mobile device. Further, some GPS systems contain a magnetic compass to determine the relative orientation of the mobile device.

While it is indeed possible for users to exchange data (e.g., applications or other data) via email or other traditional applications, current mobile devices do not exchange data with the explicit physical gesturing of the user.

### SUMMARY OF THE INVENTION

The present invention provides a new and improved method and system for transferring digital content between two or more mobile devices wherein, through the physical gesturing of a person handling one of the mobile devices, the data transfer between the mobile devices is initiated.

According to one aspect of the present invention, a method for the transfer of digital content between mobile devices through physical gesturing of an individual is introduced. More specifically, the physical actions of the individual can be sensed by the platform and used to initiate a data transfer between the mobile devices.

According to another aspect of the invention, the overall approach to system design is considered, wherein specialized components are leveraged that allow the system to determine the context and actions of the user, e.g., the presence of a specific physical action or gesture, and specifically to determine if a data exchange is sought to be initiated.

According to another aspect, a method is presented for determining the parties whose mobile devices are to receive the transferred digital content.

According to another aspect of the invention, a method is presented for determining how to package the content that is to be transmitted.

More specifically, a platform in accordance with the invention generally includes software and hardware components capable of sensing the physical actions of the user (i.e., physical movements) at the mobile device, determining if a content transfer is desired on behalf of the initiator of the transfer, presenting the initiator with one or more interfaces to determine 1) who is to receive the content and 2) which content is to be transmitted, establishing connections between the mobile device responsible for transmitting the content and the mobile device or devices that are to receive the content, network components via one or more communications networks, transmitting communications or signals between a mobile device and the one or more receiving mobile devices, and the receiving of the content by the receiving mobile device(s). With such structure, the invention provides a complete mobile delivery platform and can be created to function on all active mobile device formats (regardless of operating system).

In a specific implementation, a platform in accordance with the invention provides for the sensing of the physical actions of the user to allow for the recognition of user gestures (i.e., that can determine change in position and orientation of the mobile device). Ideally, the device would contain components that would facilitate the determination of the relative position and orientation of the devices with regard to the receiving devices. Such components would enable a specific receiver to be determined. For example, by gesturing towards a receiving device, it is possible for an individual to “throw” digital content from one device to another while avoiding the transmission of data to an unintended device that may be in close proximity to the initiating device.

An important advantage of the invention is in how the data transfer is initiated. By recognizing the high-level action of “casting” (e.g., an action similar to that performed while fishing) or similar actions, it is possible to reduce the barrier that can occur when attempting a transfer of content between mobile devices; traditional methods involve multiple steps which can slow down, or even intimidate, the user. By leveraging from physical metaphors and mental models that the user is accustomed to, the transfer of content can occur in a more natural way than traditional methods. This may be especially relevant to those who are new to (or uncomfortable with) computing.

Another advantage of the platform is in the direct transmission of the content; an intermediary is not required. In an ideal embodiment, mobile devices communicate directly with one another using established networking protocols; however, this is not a requirement for a successful implementation of the platform.

Yet another advantage of the invention is in the heightened social collaboration that can occur. First, users that are involved in the data transfer begin by using social protocols (e.g., asking for an application) and are likely to be in close proximity with one another. The act of “casting” is a visual cue that a data transfer will take place. Further, the novelty of such an approach to data transfer is especially appealing to users who are open to new technology and methods of interaction.

### BRIEF DESCRIPTION OF THE DRAWINGS

The invention, together with further advantages thereof, may best be understood by reference to the following description taken in conjunction with the accompanying drawings, wherein like reference numerals identify like elements, and wherein:

FIG. 1 is a schematic showing the primary components of a device that supports interaction and data transfer in accordance with the invention.

FIG. 2 is a schematic showing the process of data transfer between two or more mobile devices in accordance with the invention.

### DETAILED DESCRIPTION OF THE INVENTION

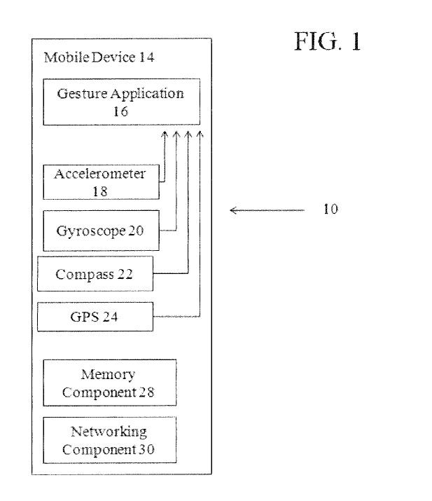

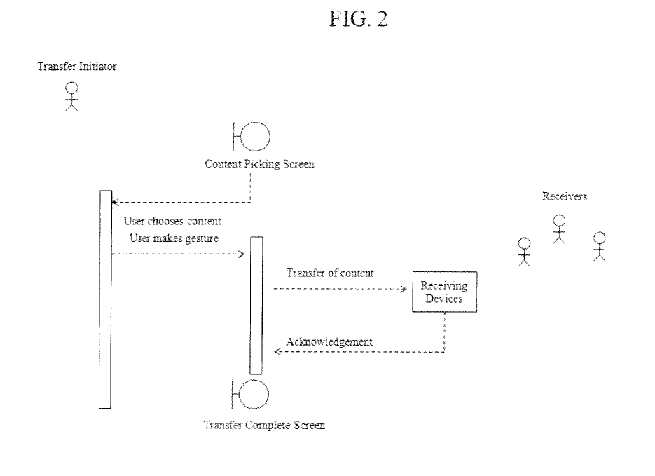

Referring to the accompanying drawings wherein like reference numerals refer to the same or similar elements, FIG. 1 shows primary components of the platform which are designated generally as 10. The primary components of a platform 10 in accordance with the invention which includes a gesture recognition application 16 located and running on a user's mobile device 14, a networking component 30 for communications, a memory component 28 for storing data (e.g., applications and data including digital content which may be transferred from the mobile device 14). The gesture recognition application 16 may be downloaded onto the mobile device 14 or pre-installed thereon. A processor or CPU is provided on the mobile device 14 to manage operation of the gesture recognition application 16, the memory component 28 and the networking component 30, and perform other functions described below. Also, the mobile device 14 includes one or more user interfaces to enable a user of the mobile device 14 to set up the gesture recognition application 16 and determine content to be transferred, described with reference to FIG. 2 below.

The mobile device 14 contains one or more components related to the pose of the mobile device, or which otherwise provide information about the mobile device 14 to the gesture recognition application 16. Such components may include one or more accelerometers 18 for determining relative positional offsets of the mobile device 14, and one or more gyroscopes 20 for determining the orientation of the mobile device 14. In one embodiment, the mobile device 14 also contains a compass 22 (which may be part of a larger component) or some other form of component to facilitate a determination of the relative location of other devices, as well as a GPS system 24.

The gesture recognition application 16 receives pose information from its primary components 18, 20, 22 and 24 which may be present in various combinations, and generally comprises software embodied on computer-readable media which analyzes the information provided by components 18, 20, 22 and/or 24 to interpret the pose of the mobile device 10. An interpretation of the pose of the mobile device 14 may be, but is not limited, to a derivation of a series of coordinates representing the position of the mobile device 14. The coordinates may be, but are not necessarily, stored in the memory component 28.

The mobile device 14 also contains a networking component 30 which is responsible for transmitting content between two or more mobile devices, including transmitting content from mobile device 14 to one or more other mobile devices and receiving content from one or more other mobile devices. The transmission occurs via a set of signals, and may be transmitted using established networking protocols, e.g., Bluetooth or wireless TCP/IP connections. Ideally, the transmission occurs directly between mobile devices, but may occur through one or more intermediary networks.

Using components such as the accelerometer 18 or the gyroscope 20, it is possible to determine rapid changes in the orientation of the mobile device 14. These components provide key information for the gesture recognition application 16, and may be used in combination with one another. For example, if an accelerometer 18 is available, it provides information about mild to rapid changes in the position of the mobile device 14. This information can also be acquired by periodically reading orientation information from the gyroscope 20 if available. By calculating the periodic differences between sets of data, it is possible to determine rapid changes in orientation. In one embodiment, both one or more gyroscopes and one or more accelerometers would be available within the mobile device 14; however, this is not a requirement for a successful implementation of the invention.

Transfer of digital content from mobile device 14 may be initiated by a throwing or casting motion. In general terms, a throwing or casting motion can be defined as a rapid change in both position and orientation; however, a rapid change in either position or orientation can also be interpreted as a casting motion. A particular change or range of changes in position and/or orientation which would constitute a throwing and/or casting motion can be determined through routine experimentation and the gesture recognition application 16 created accordingly in order to optimize the gesture recognition application 16.

FIG. 2 shows the process of transferring data between two or more devices. Note that although the invention is particularly applicable to the transfer of data in the form of digital content between two or more mobile devices, it could conceivably be applied to the transfer of data from a mobile device to a non-mobile device, such as a desktop computer. The following descriptions assumes that the data is being transferred between mobile devices.

The parties involved in the data transfer are assumed to have mobile devices similar to mobile device 14, including the gesture recognition application 16, though components 18, 20, 22 and 24 are not required in the mobile devices 14 which simply receive data. That is, only a mobile device which transfers data is required to include one or more of the component 18, 20, 22, 24 which enable determination of a gesture indicative of the desire to initiate the data transfer to another mobile device.

The data transfer process begins with a transfer initiator who desires to send data to one or more recipients (here, called receivers); the users are in close proximity with one another and local connections are established (e.g., peer-to-peer connections). Also, the position of the receivers relative to the transfer initiator may be determined, e.g., the direction of each receiver from the transfer initiator which would be used to determine whether each receiver is in the direction of the gesture. Also, the distance between the transfer initiator and each receiver may also be determined and used when the transfer initiator wants to send data to all receivers within a predetermined distance.

In addition, the initiator of the transfer must select the content that they wish to transfer. This can be done in a variety of ways, but ideally by aggregating the data to be transferred into a common repository, where it is “packaged”. By providing an interface to the process, the content of the data transfer can be visualized such that the user is aware of the transfer status as well as the information that is (or will be transferred).

In one embodiment, the application that is currently active (i.e., currently has the locus of the user) is selected for transmission, without an interface ever appearing.

If packaging does occur, additional information may be included, such as user information, preferences, or meta-data related to system performance. Once the system becomes aware that a transfer is supposed to occur (i.e., after detecting one or more casting or throwing motions performed by the initiator), the system begins the transfer of the package to the receiver(s).

The application that resides on the receiving mobile device must contain a networking device (that accepts the protocol of the initiator) that is capable of receiving digital content from the initiator. However, to receive digital content, as mentioned above, it is not necessary for the receiving mobile devices to contain components that detect the pose (orientation and position) of the device. Further, it is assumed that the user who is receiving the content desires it. In one embodiment, the receiver may be presented with a user interface to confirm that they wish to receive the content.

The transfer of data can occur across a wide variety of established networking protocols, including Bluetooth or wireless TCP/IP (or similar protocol). In a preferred embodiment, the transfer could occur across any available data connection.

In one embodiment, all members that are within a defined area (e.g., the extent to which the networking devices function) receive the content from the initiator. In a preferred embodiment, by casting in the direction of an individual receiver, the initiator may control which party is to receive the content with a finer control.

As an example, a group of several friends may be physically close (within a few feet) of one another. The system can be designed to automatically sense that friends are near and begins to establish connections (such as Bluetooth) with the devices of other members in the group. One of the members of the group (an initiator) is running an application that he wishes to share with other members of the group. By making a “throwing” gesture, the current application that is running on the initiator's mobile device is transferred to the member that lies in the throwing direction of the gesture. In another embodiment, the throwing gesture causes all members within the group to receive the application. In another application, the initiator has bundled up a package of applications or information, and transfers the package in a similar manner.

In view of the foregoing, the invention also contemplates a mobile device 14 capable of implementing these techniques which would include a gesture recognition application 16 having the functions and capabilities described above. The mobile device 14 could also include a memory component 28 including information about a user of the mobile device 14 which could be entered therein by a user interface of the mobile device 14. The application 16 could then transmit information about the user from the memory component 28 to a receiving mobile device 20.

To determine which party is to receive the content, the system must be aware of the relative position of other members in the group. This can be determined using a wide variety of methods and hardware, including orienting all mobile devices in the same direction that are to participate in the transaction as well as placing them next to one another. By leveraging the accelerometer 18 and gyroscope 20 of each mobile device in the group, relative position of the mobile devices can be obtained. If the device contains a compass 22, this can be used to replace (or reinforce) the alignment step described previously. If the device contains a high-accuracy GPS system, it may be possible to replace the information received from the accelerometer (in the previous description) with that of the GPS system. In a preferred embodiment, the device contains a high-accuracy GPS system (for position), a compass (for relative direction) and gyroscopes (for orientation). From information provided by these components, it is possible to determine the direction that a throwing gesture has been made, and thus the receiver that falls in line with the gesture.

It is to be understood that the present invention is not limited to the embodiments described above, but include any and all embodiments within the scope of the following claims. While the invention has been described above with respect to specific apparatus and specific implementations, it should be clear that various modifications and alterations can be made, and various features of one embodiment can be included in other embodiments, within the scope of the present invention.

1. A platform which interacts between a first mobile device and at least one other device, comprising:
a gesture recognition application on the first mobile device which detects, when a user is holding the first mobile device, whether the user is performing a specific gesture indicative of a desire to initiate a transfer of data from the first mobile device, and which initiates the transfer of the data to the at least one other device upon detection of the specific gesture; and
a receiving application on the at least one other device which receives the data sent by the first mobile device.

2. The platform of claim 1, wherein said gesture recognition application is arranged to detect whether the user is performing one of a set of pre-determined gestures.

3. The platform of claim 1, wherein said gesture recognition application is arranged to detect whether the user is performing one of a throwing gesture and a casting gesture.

4. The platform of claim 1, wherein said gesture recognition application is arranged to receive information about a pose of the first mobile device and detect whether the user is performing the specific gesture based on the received information about the pose of the first mobile device.

5. The platform of claim 1, further comprising:
a memory on the first mobile device which stores information about a user of the first mobile device; and
a networking application on the first mobile device for establishing communications with said receiving application on the at least one other device, wherein said networking application is arranged to transmit the stored information about the user of the first mobile device to said receiving application.

6. The platform of claim 1, wherein said receiving application is located on a second mobile device.

7. A method for initiating transfer of data between a first mobile device and at least one other device, comprising:
detecting at the first mobile device a specific gesture indicative of a desire to initiate a transfer of data from the first mobile device to the at least one other device; and
initiating the transfer of data upon detection of the specific gesture.

8. The method of claim 7, wherein the detecting comprises detecting whether the gesture is one of a casting gesture and a throwing gesture.

9. The method of claim 7, further comprising providing the at least one other device with a confirmation request to receive the transfer of data from the first mobile device by using the same or a different gesture than the gesture being used to indicate the desire to initiate the transfer of data.

10. The method of claim 7, further comprising determining the specific gesture or gestures to indicate a desire to initiate the transfer of data to enable inclusion of one or more devices and exclusion of at least one device.

11. The method of claim 7, wherein detecting the specific gesture comprises:
providing the first mobile device with at least one of an accelerometer, a gyroscope, a compass and a GPS component; and
analyzing information from said at least one of the accelerometer, the gyroscope, the compass and the GPS component, to detect performance of the gesture by the holder of the first mobile device.

12. The method of claim 7, further comprising determining the content to be transmitted from the first mobile device to the at least one other device such that when the gesture is detected, the determined content is automatically transferred to the at least one other device.

13. The method of claim 7, wherein the at least one other device is a mobile device.

14. The method of claim 7, further comprising:
establishing communications with the at least one other device prior to the transfer of content to the at least one other device;
determining a direction between the first mobile device and the at least one other device;
determining a direction of the gesture;
determining whether the at least one other device is in the direction of the gesture; and
transferring the content to the at least one other device only when the at least one other device is determined to be in the direction of the gesture.

15. A mobile device, comprising:
a monitoring system for monitoring the mobile device and determining if a change in at least one of a position and an orientation of the mobile device is indicative of a specific gesture;
a network component for transmitting and receiving data packets;
a memory component for retaining content to be transferred; and
a processor coupled to said monitoring system, said network component and said memory component for initiating transfer of content from said memory component to another device via said network component when said monitoring system determines that a change in said at least one of the position and the orientation of the mobile device is indicative of a specific gesture.

16. The mobile device of claim 15, wherein said position monitoring system comprises at least one of an accelerometer and a gyroscope which provides information about said at least one of the position and the orientation of the mobile device, and a gesture recognition application coupled to said at least one of the accelerometer and the gyroscope for determining if a change in said at least one of the position and the orientation of the mobile device is indicative of the specific gesture.

17. The mobile device of claim 15, further comprising a user interface to enable a user of the mobile device to select content to be transferred.

18. The mobile device of claim 15, wherein said processor establishes communications with the another device to which the content is to be transferred via said network component prior to the transfer of the data to the another device.

19. The mobile device of claim 18, wherein said processor determines a direction of the another device relative to the mobile device and a direction of the gesture and transfers the content to the another device only when the another device is in the direction of the gesture.

20. The mobile device of claim 18, wherein said processor determines whether the another device is within a predetermined distance to the mobile device and transfers the content to the another device only when the another device is determined to be within the predetermined distance to the mobile device.
